(19) United States
(12) Patent Application Publication
(10) Pub. No.: US 2024/0142055 A1
(43) Pub. Date: May 2, 2024

(54) Submersible System for Storing Tanks and Method of Storing Tanks on a Seabed

(71) Applicant: Deep Purple AS, Kongsberg (NO)

(72) Inventors: Svein Kjenner, Kongsberg (NO); Jan Helge Hassel, Røyken (NO); Kamrul Hasan, Kongsberg (NO)

(21) Appl. No.: 18/282,499

(22) PCT Filed: Mar. 17, 2022
(86) PCT No.: PCT/EP2022/056936

§ 371 Date: Sep. 15, 2023

(30) Foreign Application Priority Data
Mar. 18, 2021 (NO) 20210349

(51) Int. Cl. F17C 1/00; F17C 3/00; F17C 13/08

(52) U.S. Cl. CPC F17C 1/007; F17C 3/005; F17C 13/082; F17C 2201/035; F17C 2205/0107; F17C 2270/0102; F17C 2270/0128

(57) ABSTRACT

The invention relates to a submersible system (1) comprising at least a first frame structure (2) for horizontal storage of tanks (3) with a positive buoyancy in water therein, wherein the first frame structure (1) has a negative buoyancy in water and comprises at least two storage positions (4) for supporting at least two tanks (3), wherein the storage positions (4) are arranged side by side in one level and each storage position comprises at least one cradle (4) for supporting a tank (3) from below, and wherein the system (1) comprises a fastening device (6,11) having a first and a second state, wherein: i. when in the first state, the fastening device (6,11) is configured to permit positioning of a tank (3) from above into the at least one cradle (4) and; ii. when in the second state, the fastening device (6,11) is configured to secure a tank (3) positioned in the at least one cradle (4) in a radial direction of the tank (3) preventing movement of the tank (3) in a vertical upward direction; and wherein a total buoyancy of the system (1) when submerged in water, when tanks (3) are positioned in each of the storage positions, is negative. The invention also relates to an associated method of storing tanks on a seabed using the submersible system (1).

The present invention relates to a submersible system comprising a frame structure for horizontal storage of tanks therein. The invention further relates to an associated method of storing tanks on a seabed using the submersible system.

### BACKGROUND AND PRIOR ART

Renewable energy from wind or solar is in nature intermittent and the power produced varies over time. For locations relying on power from intermittent sources, i.e. locations that are not grid connected, a hydrogen based energy storage unit can be used to stabilize the renewable power production or alternatively function as the main electric power source for the location. Such locations may be offshore platforms, remote islands, fish farms, coastal industry/cities, industrial use or other power users close to water/sea with varying demand for electricity.

The intermittent power can be stabilized by producing hydrogen using electrolysis, storing the hydrogen and regenerate the hydrogen to power via fuel cells, when the intermittent power source is not producing energy.

Storing large volumes of pressurized gas such as hydrogen below water is advantageous in terms of safety. As there is no free oxygen or ignition source to set off a reaction the potential damages due to explosion and/or fire is basically eliminated under water. In addition, submerging the tanks in water ensures that the outside temperature variations are relatively small compared to storing pressurized tanks in air where the outside temperature variations may be significant.

It is an objective of the invention to provide a system and associated method for installing and storing tanks subsea.

Another objective of the invention is to provide a modular system where the number of tanks can be altered over time.

### SUMMARY OF THE INVENTION

The present invention is set forth and characterized in the independent claims, while the dependent claims describe other characteristics of the invention.

This invention can be used together with, but is not limited to, offshore hydrogen process system powered from renewable sources. Excess renewable power is stored as hydrogen, produced through water electrolysis. The basic principle of water electrolysis is known to the skilled person and will not be repeated herein.

The invention relates to a submersible system comprising at least a first frame structure for horizontal storage of tanks with a positive buoyancy in water therein, wherein the first frame structure has a negative buoyancy in water and comprises at least two storage positions for supporting at least two tanks, wherein the storage positions are arranged side by side in one level and each storage position comprises at least one cradle for supporting the tanks from below, and wherein the system comprises a fastening device having a first and a second state, wherein:
i. when in the first state, the fastening device is configured to permit positioning of a tank from above into the at least one cradle and;
ii. when in the second state, the fastening device is configured to secure a tank positioned in the at least one cradle in a radial direction of the tank preventing movement of the tank in a vertical upward direction; and
wherein a total buoyancy of the system when submerged in water, when tanks are positioned in each of the storage positions, is negative.

The frame structure is arranged for being positioned either on a seabed or a subsea support on the seabed with the tanks in a substantially horizontal orientation. Substantially horizontal is typically +−5 degrees relative a horizontal plane. The system may be a modular stackable system comprising additional frame structures.

The tanks can be pressurized tanks filled with gas, such as hydrogen (H2) or an inert gas such as nitrogen. Regardless of whether the tanks are filled with gas or not, they have a positive buoyancy in water. Thus, in order to be able to position the tanks on the seabed without floating upwards, the tanks have to be secured to the system by the fastening device. The fastening device thus prevents the tanks from floating upwards after being submerged, i.e. both during lowering through the body of water and when placed on the seabed. The fastening device secures the tanks in a radial direction of the tanks. I.e., as described above, the frame structure and the tanks are positioned on the seabed with the tanks in a substantially horizontal orientation with a radial direction of the tanks being in a vertical plane. In other words, one of the radial directions of the tanks is thus upwards towards the surface of the water and the function of the fastening device is to prevent the tank from floating upwards.

In the first frame structure, the storage positions are arranged side by side in one row at the same level. At least two storage positions are arranged along the same row, preferably with the same size and adapted to support storage tanks of the same size such that end bosses at first and second longitudinal ends of two neighboring storage tanks are flush with each other. There may be two or more storage positions in one row, dependent on the requirement in the specific project, for example three, four, . . . , eight, nine, . . . nineteen, twenty etc. storage positions.

The system can be positioned directly on the seabed or, if required, the first frame structure may be positioned on a subsea support such as a mudmat. In either case, the lowermost frame may be secured to the seabed or the subsea support to improve stability.

The cradles that provide horizontal supports for the tanks in the frame structure gives easy access for installing and securing the tanks. Furthermore, since the tanks are placed horizontally, they are easy installable due to the low required lifting height. When installed subsea, all the valves in the end boss of the tanks are easily accessible for e.g. a Remotely Operated Vehicle (ROV) simplifying connection of pipes or hoses to the different tanks.

The total buoyancy of the system shall be understood as the buoyancy of all the components forming part of the system when submerged in water, including any tanks positioned in the storage positions. The fact that the total buoyancy of the system comprising a frame structure and tanks in each storage position (either empty or filled with gas) is negative, ensures that the frame structure and the tanks, when submerged in water, sink down to the seabed. I.e., the frame structure and the tanks will not float in water even though all the tanks have a total positive buoyancy in water.

The material of the frame structure is chosen such that the total buoyancy of the system is negative in water having sufficient strength in the frame structure during lifting and installation. The frame structure itself can be made of a material with a relatively high specific gravity and the amount of material of the frame structure is chosen based on the number of cradles in the frame structure (and thus the expected positive buoyancy of the tanks positioned in the cradles). Additionally, relatively heavy object(s) such as weight(s) can be connected to the frame structure to obtain the sufficient negative buoyancy for the system when submerged in water.

The material of the frame structure, or alternatively the relatively heavy objects connected to the frame structure, may be steel, concrete or other materials or combinations of material with relatively high density that have the desired physical strength to transfer loads and retain the storage tanks in place.

In the first state of the fastening device, the fastening device is configured to permit positioning of a tank from above into the at least one cradle. This enable the possibility that a tank, while in a horizontal orientation, can be lowered down and placed into the at least one cradle I.e. in this first state, the fastening device is not obstructing or otherwise preventing the lowering of the tank into the at least one cradle.

In the second state, when submerged into water, the fastening device stops the horizontally oriented tank from floating upwards.

Each storage position may comprise at least two cradles arranged at a distance from each other in a longitudinal direction of a tank. Alternatively, each storage position may comprise one cradle with a sufficient longitudinal extent that it supports a tank therein satisfactorily. Such a longitudinal extent may be for example at least half the length of a tank to be arranged therein.

When a tank is positioned and secured in the cradle, the tank is secured in a horizontal direction or horizontal plane of the frame structure.

The at least one cradle may have a semi-circular shape adapted to the shape of the tank to be positioned therein.

The shape of the cradles is chosen based on the shape of the outer surface of the tanks to be supported therein. As the tanks normally have a cylindrical shape and a circular cross section, the cradles preferably have a semi-circular or curved opening of the same form or shape as the outer surface of the tanks.

In one aspect, one cradle and the fastening device, when connected, may form a closed opening with a circular cross-section.

The circular cross-section of the opening within the cradle and fastening device when connected may be chosen based on the outer circumference of the tank to be supported therein.

The fastening device may be fixedly connected to one end of the cradle and releasably connectable to another end of the cradle. The releasable connection may be provided by a bolt or screw or other releasable means known to the skilled person.

The fastening device may be fixedly connected to one end of the cradle and releasably connectable to another end of the cradle such that when a tank is positioned into the cradle, only the fixed end of the fastening device is connected to the cradle while the releasable end is disconnected from the cradle.

The fastening device may for example be a flexible band or strap which is formable around the outer circumference of a tank supported in the cradle. The cradle and the flexible band or strap may form a full circle when the band or strap is connected to both ends of the cradle.

Alternatively, both ends of the fastening device may be releasably connectable to respective ends of the cradle. In this embodiment, the fastening device may be of a rigid material and have a semi-circular shape which may be complementary to a semi-circular shape of the cradle such that the cradle and the fastening device forms a full circle encircling a tank supported in the cradle.

In yet another alternative, both ends of the fastening device may be separable from the ends of the cradles when not supporting a tank, whereas, after a tank has been positioned in the cradle, both ends of the fastening device are welded to the ends of the cradle, thereby securing the tank in the tank's radial direction.

The system may further comprise a support surface for supporting a second frame structure thereon and one or more guiding devices for assisting in installing another frame structure vertically onto the support surface. The support surface of the first frame structure may be of a complementary shape relative an underside of the second frame structure that is to be arranged thereon. For example, both the support surface of the first frame structure and the complementary shaped underside of the second frame structure, may be flat surfaces.

The guiding devices may be one or more so-called guideposts. Guideposts are used in subsea operations today and are vertical extending posts which cooperate with complementary shaped guide funnels on later installed equipment.

Stacking two or more frame structures on top of each other reduce the required area at the seabed. In particular, if installation of a mudmat or other seabed support is required, stacking of the frame structures eliminates the need of a dedicated mudmat or seabed support for each of the frame structures which again reduces cost in terms of amount of components and installation time.

Each storage position may comprise a stopping device for securing the tank in a longitudinal direction of the tank. The stopping device may be provided at a flange arranged about the middle of the tank(s) thereby preventing movement of the tank in a longitudinal direction when positioned and secured in the storage position.

The system may further comprise a second frame structure arranged on top of the first frame structure, and the second frame structure may be secured to the first frame structure.

The system may further comprise a third frame structure arranged on top of the second frame structure on the seabed. Even more than three frame structures, i.e. additional frame structure(s), may be arranged on top of each other, e.g. four, five, six, . . . , nine, ten frame structures may be arranged on top of each other. The additional frame structures may be secured to one or more of the frame structures below.

Standard stackable frame structures can be prefabricated and used as needed, providing large flexibility in terms of gas storage need. As the storage need may vary over the years, providing the frame structures as modules makes it easy to add or remove frame structures dependent on the demand for gas storage.

The second frame structure may be equal to the first frame structure. This may have an advantage in increased modularity and easier manufacturing as all frame structures are identical.

The fastening device may be provided on an underside of the second frame structure in such a way that when the second frame structure is secured on top of the first frame structure, any tank positioned in the storage positions of the first frame structure are prevented from movement in a vertical upward direction by the second frame structure. For example, the fastening device on the underside of the second frame structure may be in the form of semi-circular recesses arranged at positions complementary to the storage positions/cradles of the underlying frame structure such that once the second frame structure has been positioned on top of the first frame structure the storage tanks are secured from floating upwards or falling off by the presence of the semi-circular recesses on the second frame structure.

The system may further comprise a cover on top of the upper frame structure, i.e. on top of an uppermost frame structure. The cover may comprise a leak detection system. The cover may also serve as a protective cover for the system. The cover may form part of the upper frame structure and be installed together with the last, i.e. the upper frame structure, or it may be installed or submerged as a separate unit after the upper frame structure has been installed.

The leak detection system may comprise one or more sensors sensing whether there is a gas leak from any of the tanks. The cover may have a size and shape in the horizontal plane such that it extends at least the same distance in all directions relative to the tanks positioned in the frame structure, as well as the cover may have downward extending portions or skirts on all sides thereof such that gas can be trapped underneath the cover. As the gas in the tanks are lighter than water, the gas will move upwardly in the water before it is trapped under the cover. Other sensors may also be provided as part of, or below, the cover.

The fastening device may comprise:
a first protection sleeve configured to be fixedly connected both to a first end of a tank positioned in one of the cradles and to the first frame structure, and
a second protection sleeve configured to be slidably connected relative a second end of the tank positioned in the cradle and fixedly connected to the first frame structure.

The second protection sleeve may be configured to be slidably connected to a flange which is fixedly connected to the second end of the tank.

The first protection sleeve may be formed of a first part and a second part and the first part and the second part may form a circular opening when connected.

The second protection sleeve may be formed of a first part and a second part and the first part and the second part may form a circle when connected.

It is further described a method of storing tanks on a seabed, the method comprising positioning and securing tanks in storage positions in a system as described above, and submerging the system with the tanks into water and down onto a seabed.

The tanks are preferably positioned and secured in the cradles before being submerged as part of the frame structure.

In order to avoid potential explosion, the tanks are typically filled with inert gas before being shipped from production site. Similarly, the tanks are typically lowered subsea filled with inert gas. Once installed on the seabed, the inert gas can be replaced by e.g. hydrogen.

If the seabed is irregular or not sufficiently “horizontal”, a mudmat or other structure may be installed prior to submerging the frame structure. This may be done in order to provide a stable base for the first, i.e. the lowermost, frame structure. Bearing in mind that this first frame structure possibly shall support a significant weight, i.e. additional frame structure(s) arranged on top of it, it is advantageous if the first frame structure is sufficiently secured to seabed (e.g. through piles/piling) or on a mudmat.

The method may further comprise submerging a second frame structure into the water and positioning the second frame structure on top of the first frame structure. In order for this to be possible, the first frame structure may comprise one or more guiding devices for assisting in guiding another frame structure vertically onto the support surface, as described above.

The method may further comprise, prior to the step of submerging the first frame structure into the water, the steps of:
positioning a second frame structure onto the first frame structure,
connecting the second frame structure to the first frame structure. The first and second frame structures, and possible additional frame structures, can then be fastened to each other topside such that a crane can connect to either one of the frame structures and thus carry both (or all) of the frame structures as one large assembly. Lifting points such as lifting padeye may be provided on top of uppermost frame structure or alternatively lifting points may be provided on base of lowermost frame structure in the assembly.

The relative terms “upper”, “lower”, “below”, “above”, “higher” etc. shall be understood in their normal sense and as seen in a cartesian coordinate system. When mentioned in relation to seabed, “upper” or “above” shall be understood as a position closer to the water surface (relative to another component), contrary to the terms “lower” or “below” which shall be understood as a position further away from the water surface (relative another component).

### BRIEF DESCRIPTION OF THE DRAWINGS

The following drawings are appended to facilitate the understanding of the invention.

The drawings show embodiments of the invention, which will now be described by way of example only, where:

FIG. 1A is a top perspective view of a system according to the invention, where the system comprises a first frame structure and a second frame structure arranged on top of the first frame structure;

FIG. 1B is a side view of FIG. 1A;

FIG. 2A is a top perspective view of a system according to the invention, where a second frame structure is about to be positioned on top of a first frame structure, where the fastening device for securing the tanks in the first frame structure from floating in a vertical direction upwards is in the form of bands or straps;

FIG. 2B is a side view of FIG. 2A;

FIG. 3A is a side view of a system according to the invention, where a second frame structure is about to be positioned on top of a first frame structure, where the fastening device for securing the tanks in the first frame structure from floating in a vertical direction upwards is provided on an underside of the second frame structure;

FIG. 3B is a side view of a system according to the invention, where the second frame structure of FIG. 3A has been positioned on top of the first frame structure;

FIGS. 4A-4D show different examples of stopping device for preventing longitudinal movement of the tanks when positioned in the cradles, where FIG. 4A shows an example where the tank has a rib around a centre portion thereof for cooperation with stopping devices on the frame structure, FIG. 4B shows an example where the tank has a rib around an end portion for cooperation with stopping devices on the frame structure, FIG. 4C shows an example where the tank has one rib around each of the end portions for cooperation with stopping devices on the frame structure, and FIG. 4D shows an example where an end boss of the tank is secured to a stopping device on the frame structure;

FIG. 5A is a side perspective view of an example of a row of storage positions with a cradle where fastening device are fixedly connected to one end of the cradle and releasably connectable to another end of the cradle;

FIG. 5B is a side view of an exemplary cradle with a fastening device that is releasable connected to both ends of the cradle;

FIG. 5C is a top view of FIG. 5B;

FIG. 6A shows a tank and an exploded view of a fastening device in the form a first protection sleeve and a second protection sleeve, and wherein the first protection sleeve is configured to be fixedly connected both to a first end of the tank positioned in one of the cradles and to the first frame structure and the second protection sleeve is configured to be slidably connected relative a second end of the tank positioned in the cradle and fixedly connected to the first frame structure;

FIG. 6B shows the tank and the fastening device of FIG. 6A about to be installed as part of a system with additional tanks in first frame structure;

FIG. 6C shows that the tank and the fastening device of FIGS. 6A and 6B have been installed as part of the system with additional tanks in first frame structure, and where a cover has been mounted on top pf the first frame structure.

FIG. 6D is an exploded view of the some of the components forming part of the system in FIG. 6D;

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

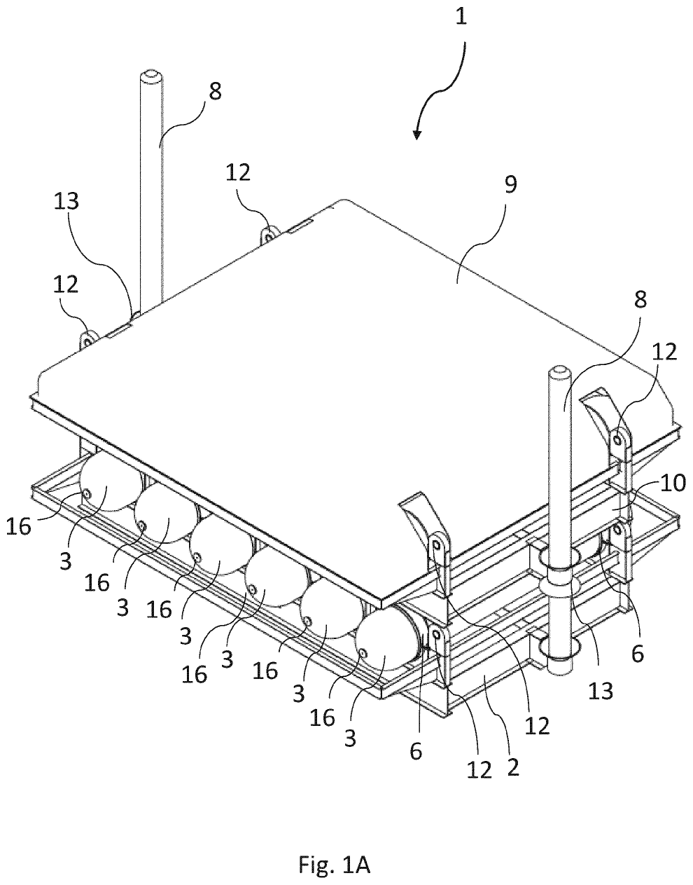

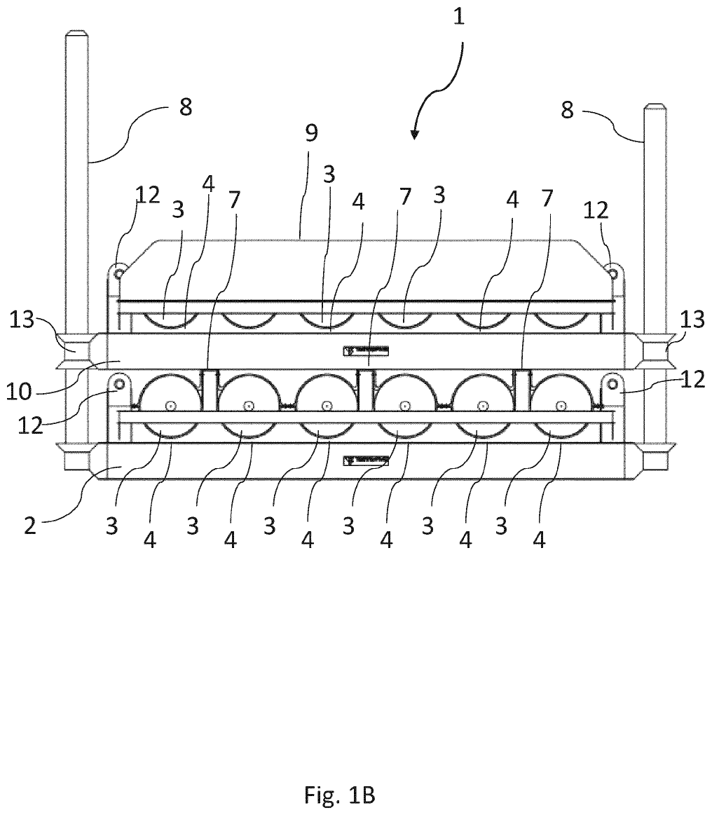

FIG. 1A is a top perspective view of a system 1 according to the invention, where the system 1 comprises a first frame structure 2 and a second frame structure 10 arranged on top of the first frame structure 2. FIG. 1B is a side view of FIG. 1A.

The first frame structure 2 is shown with a plurality of storage positions 4 comprising cradles 4 for supporting a storage tank 3 in each of the storage positions/cradles 4. Referring to FIG. 1B the second frame structure 10 also comprises a plurality of storage positions 4. The storage positions 4 are arranged in a row in the first frame structure 2. The storage positions 4 are arranged side-by-side along the row such that the end bosses 16 of the storage tanks 3 supported by the storage positions 4 in the first frame structure 2 are flush with the end bosses 16 on the neighboring tanks 3. Each of the storage positions comprise at least one cradle 4 for supporting a tank 3 from below. Fastening devices 6 in the form of a band or strap 6 are provided for preventing the tanks 3 to float upwards when the system 1 is submerged in water. The bands or straps 6 have a first and second state. In the first state, the band or strap 6 are either completely separated from the respective cradle 4 permitting uninterrupted positioning of a horizontally arranged tank 3 into the storage position/cradle 4. When in the second state (as shown e.g. in FIG. 1A), the band or strap 6 secures the tank 3 in the cradle 4 and prevents radial movement of the tank 3 upwardly when submerged in water.

The first and second frame structures 2, 10 are shown with lifting points 12 in the form of lifting padeyes 12 for lifting by a crane or similar (not shown). In order to obtain a stable lift, the lifting points 12 are typically arranged at or close to the corners of the frame structures 2, 10.

The first frame structure 2 is disclosed with two guiding devices 8 in the form of guide-posts 8 for interaction with guide funnels 13 on the second frame structure 10. The guide-posts 8 and guide funnels 13 assist in guiding the second frame structure 10 vertically onto the first frame structure 2. Although it is only disclosed two frame structures 2, 10 in FIG. 1A, the guide-posts 8 are preferably of a sufficient length for guiding more than only the second frame structure 10 thereon. For example, the guide-posts 8 may be of a sufficient length for guiding two, three, four or more frame structures on top of the first frame structure 2. A mudmat (not shown) may be provided in a lower portion or below the first frame structure 2 for providing a horizontal stable support for the first frame structure 2 and any subsequent frame structures 10 positioned thereon.

A cover 9 is arranged on top of the second frame structure 10. The cover 9 may protect the system 1 from unintentionally falling objects and or fishing trawls etc.

The second frame structure 10 is supported by the first frame structure 2 on support surfaces 7 of the first frame structure 2. The support surfaces 7 of the first frame structure 2 are preferably of a complementary shape relative an underside of the second frame structure 10 such that the second frame structure 10 is stable once positioned on top of the first frame structure 2.

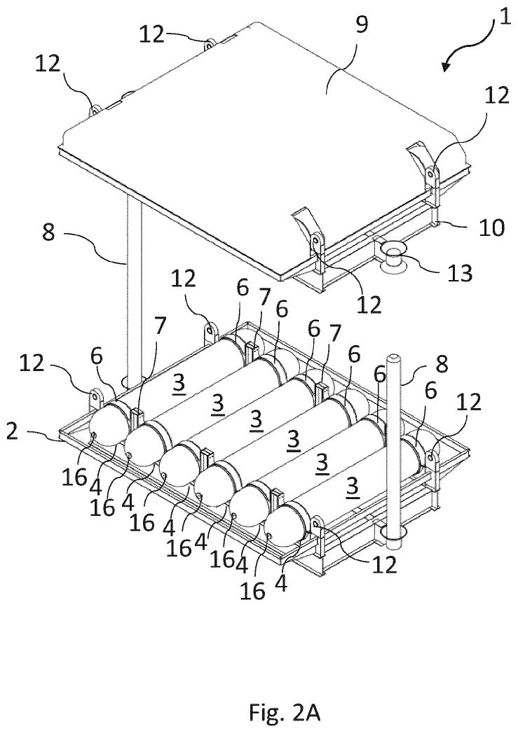

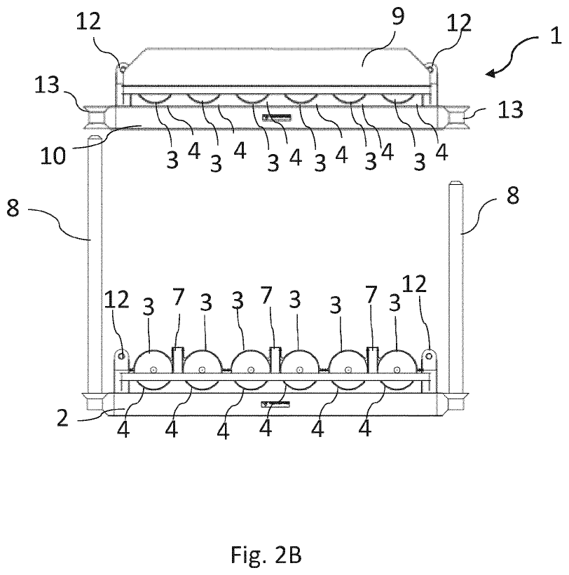

FIG. 2A is a top perspective view of a system 1 according to the invention, where a second frame structure 10 is about to be positioned on top of a first frame structure 2, and where the fastening device for securing the tanks 3 in the first frame structure 1 from floating in a vertical direction upwards is in the form of bands or straps 6. FIG. 2A further shows some more details of the storage positions 4 of the first frame structure 2, where the storage positions 4 are arranged in a row in one level. Two sets of bands or straps 6 are shown for each cradle 4. In FIG. 2A, the bands or straps 6 are arranged at end portions of the storage positions 4, i.e. close to the respective longitudinal ends of the tanks 3 positioned in the cradles 4. A number of support surfaces 7 for supporting the second frame structure 10 are arranged at intervals between the tanks 3 for providing a stable support from below for the second frame structure 10 (and any subsequent frame structures arranged on top of the second frame structure 10). Due to the presence of the cover 9 on the second frame structure 10, the second frame structure 10 will serve as the uppermost frame structure of the system 1. The cover can be mounted onto the second frame structure 10 (or any other uppermost frame structure of the system 1) prior to installing the second frame structure 10 or in a separate run after the second frame structure 10 has been positioned on top of the first frame structure 2.

FIG. 2B is a side view of FIG. 2A.

Although FIGS. 2A and 2B show installation of the first and second frame structures 2, 10 in separate runs, it is possible to position the second frame structure 10 onto the first frame structure 2 while the first and second frame structures are topside, and then, once the second frame structure 10 has been secured to the first frame structure 2, the system 1 including the first and second frame structures 2, 10 can be installed in a single operation.

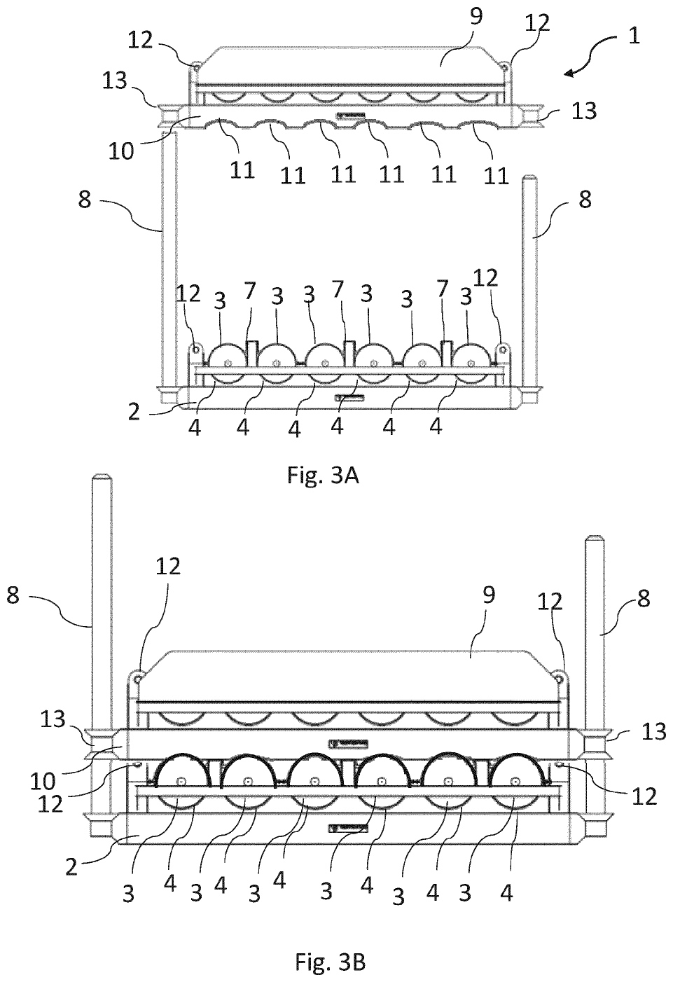

In FIG. 3A it is shown a side view of a system 1 according to the invention, where a second frame structure 10 is about to be positioned on top of a first frame structure 2. In FIG. 3B, the second frame structure of FIG. 3A has been positioned on top of the first frame structure 2. The fastening device 11 for securing the tanks 3 in the first frame structure 3 from floating in a vertical direction upwards is provided on an underside of the second frame structure 10. The fastening device 11 on the underside of the second frame structure 10 is in the form of semi-circular recesses 11 arranged at positions complementary to the storage positions/cradles 4 of the underlying frame structure 2 such that once the second frame structure 10 has been positioned on top of the first frame structure 2 (see FIG. 3B) the storage tanks 3 are secured from floating upwards by the presence of the semi-circular recesses 11 on the second frame structure 2.

The remaining features of the system 1 in FIGS. 3A and 3B (except for the fastening device) are similar to the disclosure of FIGS. 1A 1B, 2A and 2B, and will not be repeated herein.

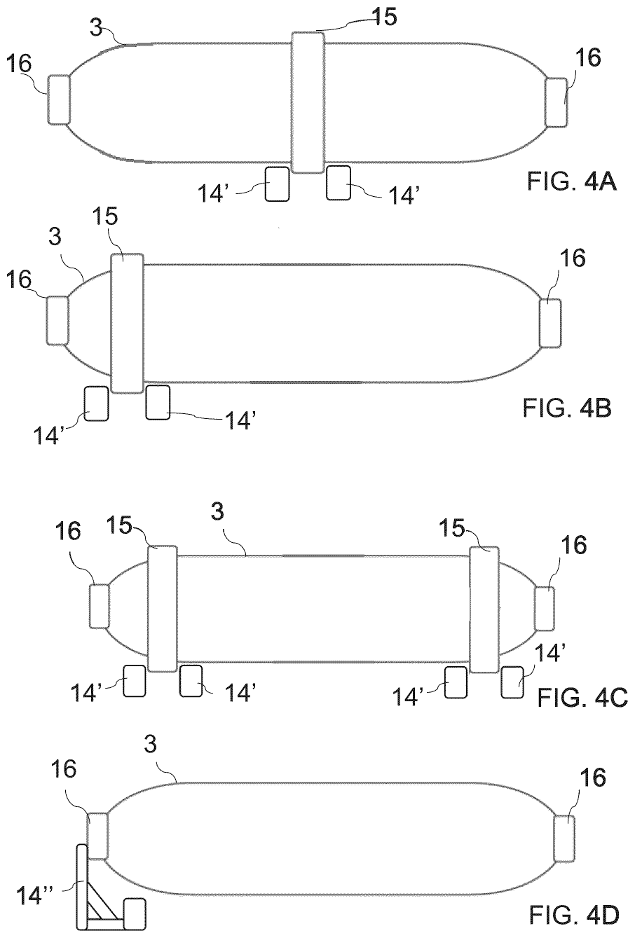

FIGS. 4A-4D show different examples of stopping devices 14′, 14″ for preventing longitudinal movement of the tanks 3 when positioned in the cradles 4. To better illustrate the stopping devices 14′, 14″ and their interaction with the tanks 3, the frame structure and cradles have been omitted in FIGS. 4A-4D. FIG. 4A shows an example where the tank 3 is provided with a rib 15 with an increased diameter around a centre portion of the tank 3. The rib 15 is configured for cooperation with stopping device 14′ on the frame structure, where the stopping devices 14′ are arranged on both sides of the rib 15 preventing longitudinal movement of the tank 3. FIG. 4B shows an example where the tank 3 is provided with a rib 15 around an end portion of the tank 3. Similar to FIG. 4A, the rib 15 is configured for cooperation with stopping devices 14′ on the frame structure, where the stopping devices 14′, 14″ are arranged on both sides of the rib 15 preventing longitudinal movement of the tank 3. FIG. 4C shows an example where the tank 3 is provided with two ribs 15, i.e. one rib 15 around each of the end portions of the tank 3 for cooperation with stopping devices 14′ on the frame structure. FIG. 4D shows an example where an end boss 16 of the tank is secured to a stopping device 14″ fixed to the frame structure. The end boss 16 can be bolted, welded or otherwise fixedly connected to the stopping device 14″.

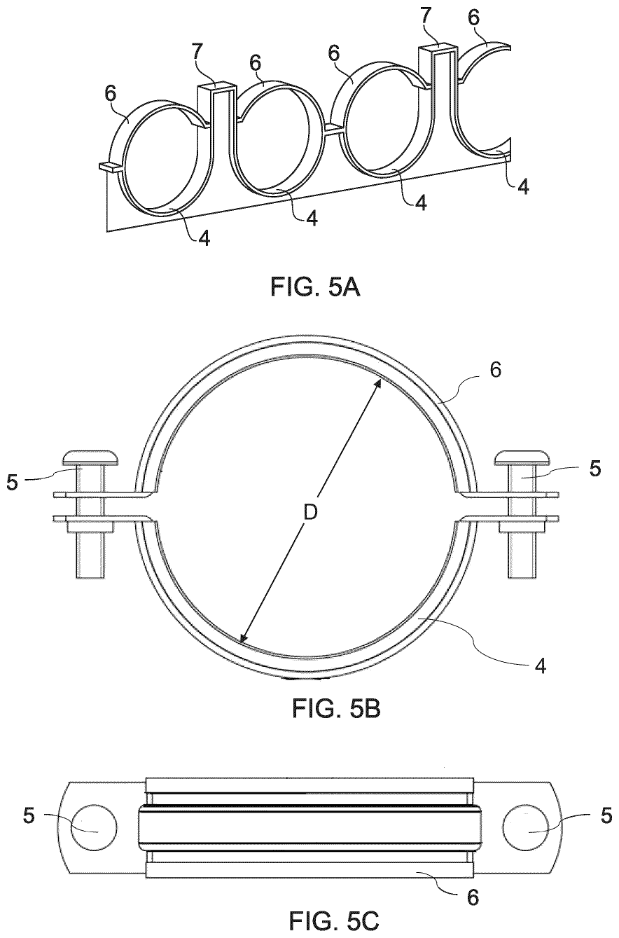

FIG. 5A is a side perspective view of an example of a row of storage positions 4 with a cradle 4 where a fastening device in the form of band or strap 6 is fixedly connected to one end of the cradle 4 and releasably connectable to another end of the cradle 4. The cradle 4 has a semi-circular shape. Support surfaces 7 are provided at appropriate intervals along the row for supporting one or more additional frame structures (not shown) from below.

FIG. 5B is a side view of an exemplary cradle 4 with a fastening device 6 that is releasably connected to both ends of the cradle 4. As illustrated by cross-section D, the cradle 4 and the band or strap 6 form a circular cross section when the band or strap 6 is connected in both ends of the cradle 4. The ends of the band or strap 6 can be connected to the respective ends of the cradle 4 by bolt, screw 5 or similar means known to the person skilled in the art.

FIG. 5C is a top view of FIG. 5B.

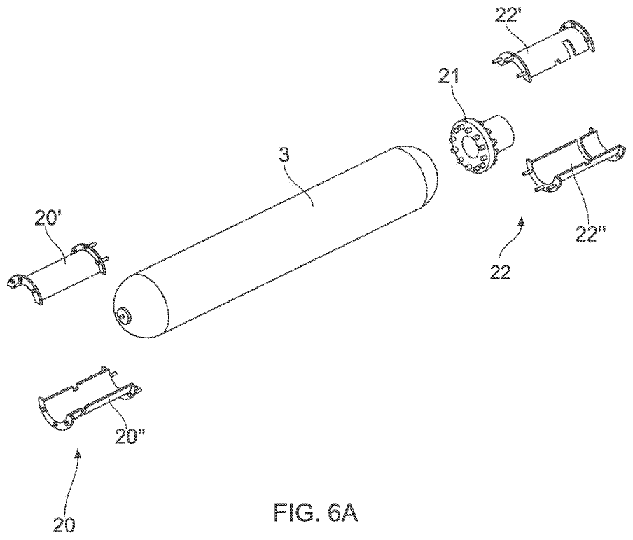

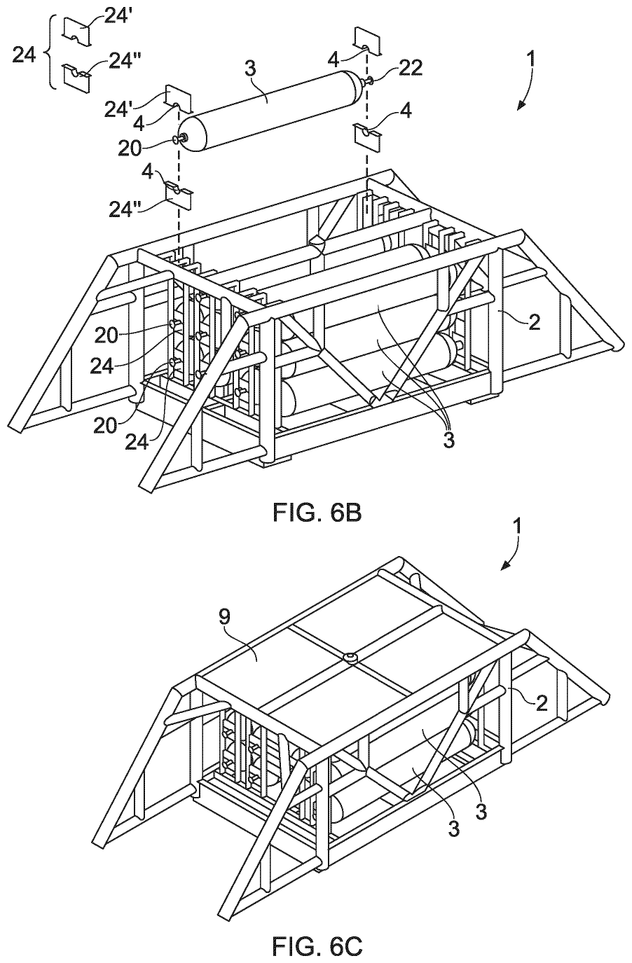

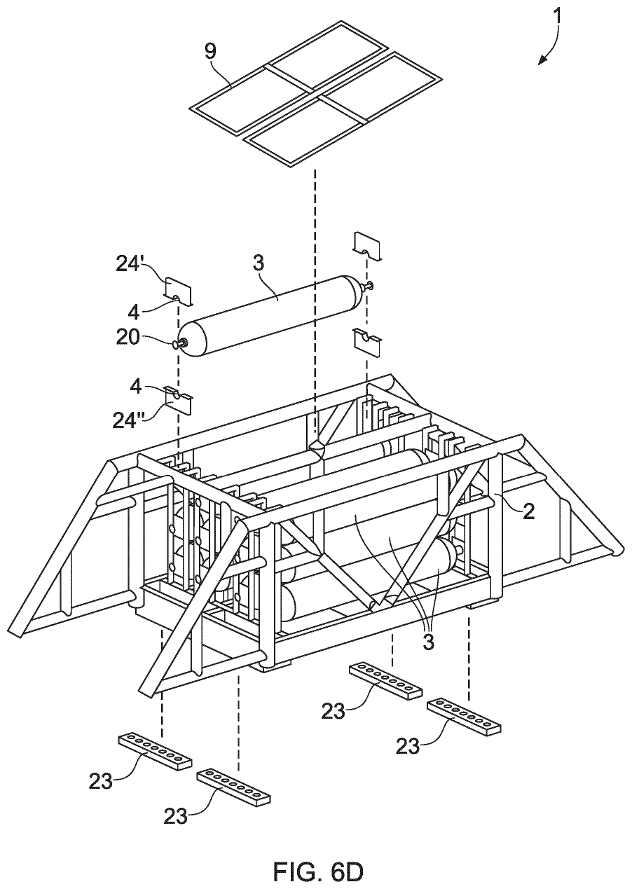

FIG. 6A shows a tank 3 and an exploded view of a fastening device 20, 22 in the form a first protection sleeve 20 and a second protection sleeve 22. The first protection sleeve 22 is configured to be fixedly connected both to a first end of the tank 3 which is positioned in one of the cradles 4 (cradles not shown in FIG. 6A) and to the first frame structure 2 (not shown in FIG. 6A).

A flange 21 of a cylindrical shape with a smooth surface is mounted on the second end of the tank 3.

The first protection sleeve 20 is formed of a first part 20′ and a second part 20″. The first part 20′ and the second part 20″ have a semi-circular shape such that when the first part 20′ and the second part 20″ are connected, they form a circular opening.

Similarly, the second protection sleeve 22 is formed of a first part 22′ and a second part 22″. The first part 22′ and the second part 22″ have a semi-circular shape such that when the first part 22′ and the second part 22″ are connected, they form a circular opening. The second protection sleeve 22 is configured to be fixedly connected to the first frame structure 2 and slidably connected relative to the flange 21.

One or more lines or cables (not shown) can extend from the ends of the tank through the first and second protection sleeves 20, 22 and to ROV-operated valves etc. while being protected from damage by the respective protection sleeves 20, 22.

FIG. 6B shows the tank 3 and the fastening device of FIG. 6A about to be installed as part of a system with additional tanks 3 in first frame structure 2. The first protection sleeve 20 and the second protection sleeve 22 are supported in cradles 4 formed of complementary semi-circular recesses of upper support bracket 24′ and lower support bracket 24″ of support brackets 24. The support brackets 24 are connected to the first frame structure 2.

FIG. 6C shows that the tank 3 and the fastening device 20, 22 of FIGS. 6A and 6B have been installed as part of the system 1 with additional tanks 3 in first frame structure 2. A cover 9 has been mounted on top of the first frame structure 2.

As seen in the front end of the first frame structure 2, the protection sleeve 20 extends outside the support brackets 24 such that they are easy accessible by ROVs etc. for connecting valves etc. thereon.

FIG. 6D is an exploded view of the some of the components forming part of the system 1 in FIG. 6D Deadweight in the form of concrete blocks 23 are shown connectable to the bottom of the first frame structure 1.

In the preceding description, various aspects of the submersible system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the submersible system, which are apparent to persons skilled in the art to which the disclosed subject matter pertains, are deemed to lie within the scope of the present invention as defined in the attached claims.

### LIST OF REFERENCES

| | |
|---|---|
| 1 | System |
| 2 | First frame structure |
| 3 | Tank |
| 4 | Storage position/cradle |
| 5 | Bolt, screw |
| 6 | Band, strap |
| 7 | Support surface |
| 8 | Guiding devices |
| 9 | cover |
| 10 | Second frame structure |
| 11 | Fastening device underside/semi-circular recess |
| 12 | Lifting point/lifting padeye |
| 13 | Guide funnel |
| 14′, 14″ | Stopping device |
| 15 | Rib |
| 16 | End boss |
| 20 | First protection sleeve |
| 20′ | First part of first protection sleeve |
| 20″ | Second part of first protection sleeve |
| 21 | Flange |
| 22 | Second protection sleeve |
| 22′ | First part of second protection sleeve |
| 22″ | Second part of second protection sleeve |
| 23 | Concrete blocks |
| 24 | Support bracket |
| 24′ | Upper support bracket |
| 24″ | Lower support bracket |
| D | Cross section |

1. A subsea system comprising:
at least a first frame structure for horizontal storage of tanks having a positive buoyancy in water;
wherein the first frame structure has a negative buoyancy in water and comprises at least two storage positions for supporting at least two tanks;
wherein the storage positions are arranged side by side in one level and each storage position comprises at least one cradle for supporting a tank from below; and
wherein the system comprises a fastening device having a first state and a second state, wherein:
i. when in the first state, the fastening device is configured to permit positioning of a tank from above into the at least one cradle; and
ii. when in the second state, the fastening device is configured to secure a tank positioned in the at least one cradle in a radial direction of the tank to prevent movement of the tank in a vertical upward direction; and
wherein a total buoyancy of the system when submerged in water, and with tanks positioned in each of the storage positions, is negative.

2. The system according to claim 1, wherein each storage position comprises at least two cradles arranged at a distance from each other in a longitudinal direction of a tank supported by the cradles.

3. The system according to claim 1, wherein the at least one cradle has a semi-circular shape.

4. The system according to claim 1, wherein one of said at least one cradle the fastening device when connected, form a closed opening with a circular cross-section.

5. The system according to claim 1, wherein the fastening device is fixedly connected to one a first end of the at least one cradle and releasably connectable to another a second end of the at least one cradle.

6. The system according to claim 1, further comprising a support surface for supporting a second frame structure thereon and one or more guiding devices for assisting in installing the second frame structure vertically onto the support surface.

7. The system according to claim 1, wherein each storage position comprises a stopping device for securing the tank in a longitudinal direction of the tank.

8. The system according to claim 1, further comprising:
a second frame structure arranged on top of the first frame structure;
wherein the second frame structure is secured to the first frame structure.

9. The system according to claim 8, wherein the second frame structure is equal to the first frame structure.

10. The system according to claim 8, wherein the fastening device is provided on an underside of the second frame structure.

11. The system according to claim 1, further comprising a cover on an uppermost one of said at least one frame structure.

12. The system according to claim 1, wherein the fastening device comprises:
a first protection sleeve configured to be fixedly connected both to a first end of a tank positioned in one of the cradles and to the first frame structure; and
a second protection sleeve configured to be slidably connected relative a second end of the tank positioned in the cradle and fixedly connected to the first frame structure.

13. The system according to claim 12, wherein the second protection sleeve is configured to be slidably connected to a flange which is fixedly connected to the second end of the tank.

14. The system according to claim 12, wherein the first protection sleeve is formed of a first part and a second part and wherein the first part and the second part form a circular opening when connected.

15. The system according to claim 14, wherein the second protection sleeve is formed of a first part and a second part, and wherein the first part and the second part form a circle when connected.

16. A method of storing a number of tanks on a seabed, comprising:
positioning and securing the tanks in corresponding storage positions in a system according to claim 1; and
submerging the system, with the tanks secured therein, into water and down onto a seabed.

17. The method according to claim 16, further comprising:
submerging a second frame structure into the water and positioning the second frame structure on top of the first frame structure.

18. The method according to claim 16, further comprising, prior to the step of submerging the first frame structure into the water, the steps of:
positioning a second frame structure onto the first frame structure; and
connecting the second frame structure to the first frame structure.
